(19) United States
(12) Patent Application Publication
(10) Pub. No.: US 2018/0336028 A1
(43) Pub. Date: Nov. 22, 2018

(54) PROCESSING DEVICE AND CONTROL METHOD OF PROCESSING DEVICE

(71) Applicant: FUJITSU LIMITED, Kawasaki-shi (JP)

(72) Inventors: Yuhei TAKATA, Kawasaki (JP); Kenichi KITAMURA, Kawasaki (JP)

(73) Assignee: FUJITSU LIMITED, Kawasaki-shi (JP)

(21) Appl. No.: 15/980,115

(22) Filed: May 15, 2018

(30) Foreign Application Priority Data
May 18, 2017 (JP) 2017-099172

(51) Int. Cl. G06F 9/30; G06F 7/483

(52) U.S. Cl. CPC G06F 9/3001; G06F 7/483

(57) ABSTRACT

A processing device includes an instruction control unit configured to issue an instruction, an operation unit configured to perform a floating-point operation in accordance with an instruction issued from the instruction control unit, a detection unit configured to detect a subnormal number from data related to the floating-point operation performed in the operation unit, and a processing unit configured to process the data in a case in which a subnormal number is included in the data. When committing the instruction, in a case in which a subnormal number was detected by the detection unit from the data related to the floating-point operation performed in accordance with the instruction, the instruction control unit transits to a subnormal processing mode for processing a subnormal number, instructs the operation unit to re-execute the instruction, and instructs the processing unit to process the detected subnormal number.

### CROSS-REFERENCE TO RELATED APPLICATION

This application is based upon and claims the benefit of priority of the prior Japanese Patent Application No. 2017-099172, filed on May 18, 2017, the entire contents of which are incorporated herein by reference.

### FIELD

The embodiments discussed herein relate to a processing device and a control method of a processing device.

### BACKGROUND

A standard format of a floating-point number is defined in the IEEE 754-2008, and a floating-point number is expressed, as illustrated in FIG. 13A, using a sign (S) 1301, an exponent (E) 1302, and a significand (F) 1303. Also, as illustrated in FIG. 13B, in addition to a normal number, a subnormal number, infinity, NaN, and zero are defined in the standard format of a floating-point number.

In a normal number, an integer value of 1 is implied in the significand, in addition to a fractional part, and a normal number is expressed as “(−1)^{s}×2^{(E-bias)}×1.F”. This bit representing an integer part (hereinafter referred to as an “integer bit”) is referred to as a hidden bit. Among the rest of the four numbers expressed by the floating-point number format, only a subnormal number is required to perform numerical calculation. In the subnormal number, an integer part (hidden bit) is not 1, an exponent (E) is 0, and the subnormal number is expressed as “(−1)^{s}×2^{(E-bias+1)}×0.F”.

A difference between a format of a normal number and a format of a subnormal number is a value of a hidden bit and a value of an exponent. Further, with respect to a floating-point operation of a normal number and a subnormal number, one of the differences is a rounding process. When processing a normal number, if an integer bit of an arithmetic operation result becomes zero, left-shifting of a significand is performed until an integer bit becomes 1. This process is referred to as normalization, and the rounding process is applied to a value having been normalized. Conversely, in a case in which an arithmetic operation result becomes a subnormal number, it is determined that the normalization should be performed to a value in a state in which an integer bit is 0. Therefore, if a rounding process were performed to a subnormal number after performing left-shifting of a significand until an integer bit became 1, similar to a normal number, the calculated result would be different.

The following three methods (<1> to <3>) are used as method of handling a subnormal number:

<1> a subnormal number is detected by an operation unit and the subnormal number is processed by software,
<2> a circuit for handling a subnormal number is added to an operation unit, and a subnormal number is processed by only the operation unit,
<3> a subnormal number is processed by hardware, but a subnormal number is processed in coordination with a control circuit, which is a different process from a normal process.

With respect to method <1>, Patent Documents 1, 2, and 3 disclose a method for detecting an exception processing including a subnormal number, in a processor having multiple computing resources supporting multithreading, SIMD (Single Instruction Multiple Data) operation, and the like. Also, in Patent Documents 4, 5, and 6, a method for detecting a subnormal number in a high-speed and efficiently is disclosed. Though all Patent Documents 1 to 6 disclose a method of detecting a subnormal number by hardware, a practical process to be performed by software is not disclosed.

With respect to method <2>, Patent Documents 7, 8, and 9 disclose a method for processing a subnormal number using only an operation unit by adding a circuit for handling a subnormal number to a floating-point operation unit. Disclosed is a method for adjusting a shift amount for normalization when an output is a subnormal number, in addition to a method for adjusting a hidden bit and an exponent when an input is a subnormal number.

With respect to method <3>, Patent Documents 10, 11, and 12 disclose an operation unit for detecting appearance of a subnormal number, an operation unit for performing a pre-processing of an input of a subnormal number, an operation unit for performing a post-processing of an output of a subnormal number, and a method for processing a subnormal number using the operation units when a subnormal number is detected. Patent Document 10 discloses a method for dividing a floating-point operation instruction into multiple microinstructions and for performing the instruction by combining the microinstructions. In a processing device disclosed in Patent Document 11, a detecting circuit and one of a normalization circuit and a de-normalization circuit are provided to an input and an output, and the processing device processes a subnormal number by feeding back a result of each processing circuit (the normalization circuit and the de-normalization circuit) as necessary. Patent Document 12 discloses a processing device including a circuit for detecting an input of a subnormal number and for performing pre-processing. When an input is a subnormal number, the processing device is configured to perform operation using a pre-processed result of the circuit.

Because an operation of a subnormal number by software is implemented by combining many instructions, latency required to perform the operation tends to be longer. Conversely, if a circuit for processing a subnormal number were added to an operation unit, the circuit would become complicated and might increase delay in a case in which a subnormal number is not present. Further, if a processing device were to be configured such that a floating-point operation instruction is executed using multiple microinstructions, control of hardware would become complex. Especially, in a method disclosed in Patent Document 11 or 12, because a process branches at a point in time when a subnormal number is detected, and execution of subsequent instructions is suppressed, control would become complicated.

The following is reference documents:
[Patent Document 1] U.S. Pat. No. 9,026,705,
[Patent Document 2] U.S. Pat. No. 7,373,489,
[Patent Document 3] U.S. Pat. No. 6,378,067,
[Patent Document 4] U.S. Pat. No. 7,437,538,
[Patent Document 5] U.S. Pat. No. 6,151,669,
[Patent Document 6] Japanese National Publication of International Patent Application No. 2002-508864,
[Patent Document 7] U.S. Pat. No. 9,317,250,
[Patent Document 8] U.S. Pat. No. 8,260,837,
[Patent Document 9] U.S. Pat. No. 5,943,249,
[Patent Document 10] Japanese Laid-Open Patent Publication No. 2015-228226,
[Patent Document 11] Japanese Laid-Open Patent Publication No. 8-305546,
[Patent Document 12] Japanese Laid-Open Patent Publication No. 6-161708.

### SUMMARY

A processing device according to one embodiment includes an instruction control unit configured to issue an instruction, an operation unit configured to perform a floating-point operation in accordance with an instruction issued from the instruction control unit, a detection unit configured to detect a subnormal number from data related to the floating-point operation performed in the operation unit, and a processing unit configured to process the data in a case in which a subnormal number is included in the data. When committing the instruction, in a case in which a subnormal number was detected by the detection unit from the data related to the floating-point operation performed in accordance with the instruction, the instruction control unit causes the processing device to transit to a subnormal processing mode for processing a subnormal number, instructs the operation unit to re-execute the instruction, and instructs the processing unit to process the detected subnormal number.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a processing device according to a first embodiment;

FIG. 2 is a flowchart illustrating an example of an operation according to the first embodiment;

FIG. 3 is a diagram illustrating a configuration example of an operation execution unit according to the first embodiment;

FIG. 4 is a diagram illustrating a configuration example of a floating-point multiplier-accumulator unit illustrated in FIG. 3;

FIG. 5 is a diagram illustrating an example of a configuration of a format circuit illustrated in FIG. 4;

FIG. 6 is a diagram illustrating an example of a configuration of an exponent calculation circuit A illustrated in FIG. 4;

FIG. 7 is a diagram illustrating an example of a configuration of a subnormal number processing circuit illustrated in FIG. 3;

FIG. 8 is a diagram illustrating a configuration example of an operation execution unit according to a second embodiment;

FIG. 9A is a diagram illustrating an example of a configuration of a floating-point reciprocal table operation unit illustrated in FIG. 8;

FIG. 9B is a diagram illustrating an example of a configuration of an exponent calculation circuit illustrated in FIG. 9A;

FIG. 10 is a diagram illustrating an example of a configuration of a subnormal number processing circuit illustrated in FIG. 8;

FIG. 11 is a diagram illustrating a configuration example of an operation execution unit according to a third embodiment;

FIG. 12 is a diagram illustrating an example of a configuration of a control circuit illustrated in FIG. 11; and

FIGS. 13A and 13B are diagrams illustrating formats of a floating-point number.

### DESCRIPTION OF EMBODIMENT

Hereinafter, embodiments of the present disclosure will be described with reference to the drawings.

### First Embodiment

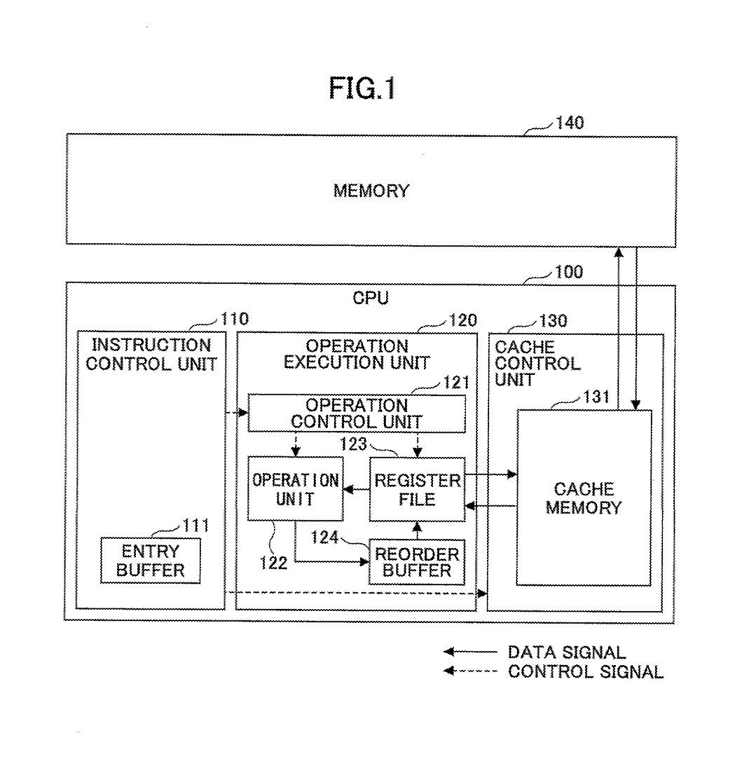

A first embodiment will be described. FIG. 1 is a diagram illustrating a configuration of a CPU (Central Processing Unit), which is an example of a processing device according to the first embodiment. The CPU 100 includes an instruction control unit 110, an operation execution unit 120, and a cache control unit 130.

Instructions executed in the CPU 100 are issued from the instruction control unit 110. The instruction control unit 110 performs operations such as fetching an instruction, decoding the instruction, and completing (committing) the instruction. In the present embodiment, instructions are executed regardless of an original order in a program (out-of-order execution), and when the instructions are committed, reorder of the instructions is performed. The reorder of the instructions is realized by storing an instruction that an operation has terminated into an entry buffer 111 and committing the instructions in an order of a program. Note that a case in which out-of-order execution is used will be described in the present embodiment, but the embodiment is not necessarily limited to the case. In-order execution may also be used in the present embodiment.

The operation execution unit 120 includes an operation control unit 121, an operation unit 122, a register file 123, and a reorder buffer 124, and executes a process in accordance with an instruction issued by the instruction control unit 110. The operation control unit 121 determines to which operation unit an instruction issued from the instruction control unit 110 is to be dispatched, and sends a notification to the operation unit 122. The operation unit 122 includes a floating point operation unit and a subnormal number processing circuit, and performs an operation in accordance with an instructed instruction. An operation result by the operation unit 122 is stored into the reorder buffer 124, and when an instruction is committed (completed) by the instruction control unit 110, the operation result stored in the reorder buffer 124 is written to the register file 123. The register file 123 stores data to be used for an arithmetic operation, operation result data, and the like.

The cache control unit 130 includes a cache memory 131. The cache control unit 130 performs control related to the cache memory 131, and performs control related to data transfer between the register file 123 in the operation execution unit 120 and the cache memory and to data transfer between the cache memory 131 and the memory 140. The cache memory 131 stores part of data stored in the memory (which is a main memory) 140.

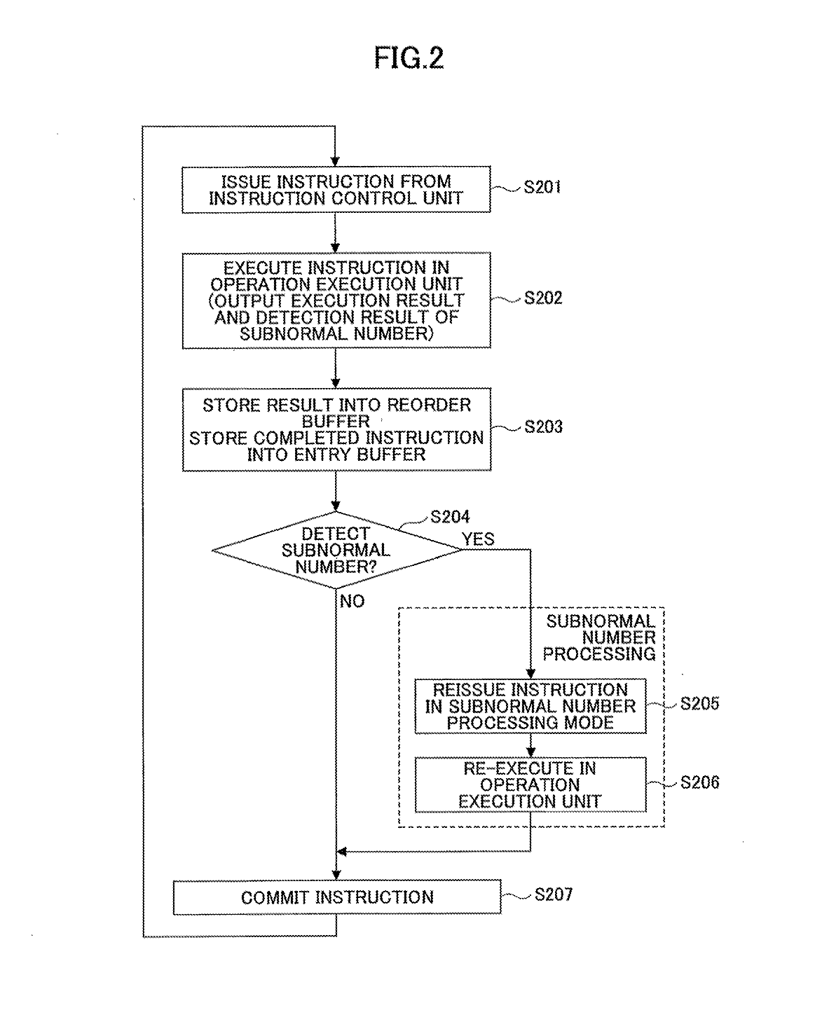

FIG. 2 is a flowchart illustrating an example of an instruction execution process performed in the CPU 100. At step S201, the instruction control unit 110 issues an instruction to the operation execution unit 120. At step S202, the operation execution unit 120 executes the instruction received from the instruction control unit 110 in the operation unit 122. At this point, the operation unit 122 in the operation execution unit 120 performs detection of a subnormal number from input data or output data (hereinafter, input data, output data, or a combination of input data and output data may be referred to as “I/O data”), to determine whether a subnormal number is present or not in the input data or the output data. When an arithmetic operation is completed, the operation unit 122 in the operation execution unit 120 outputs an operation result and a result of detection of a subnormal number.

At step S203, the operation result output by the operation unit 122 in the operation execution unit 120 is stored into the reorder buffer 124, and the processed instruction and the result of detection of a subnormal number corresponding to the instruction are stored into the entry buffer 111 in the instruction control unit 110. For example, a determination flag may be provided in the entry buffer 111, and the determination flag may be turned on if a subnormal number is detected. The result of detection of a subnormal number is retained until the corresponding instruction is completed. In the above description, the processed instruction and the result of detection of a subnormal number are stored in the entry buffer 111, but the result of detection of a subnormal number may be stored in a storage region other than the entry buffer 111, as long as the result of detection of a subnormal number is stored in association with the corresponding processed instruction.

Next, at step S204, when the processed instruction is to be committed (when the processed instruction comes to a top of the entry buffer 111), the instruction control unit 110 determines, with respect to the instruction to be committed, whether a subnormal number has been detected or not, based on the result of detection of a subnormal number corresponding to the instruction to be committed. As a result, if it is determined that a subnormal number has been detected (YES at step S204), the CPU 100 transits to a subnormal number processing mode and performs a subnormal number processing. In the subnormal number processing mode, the CPU 100 operates in a single instruction mode for suppressing execution of instructions subsequent to the processed instruction in an order of a program. The CPU 100 discards values stored in the entry buffer 111 and the reorder buffer 124, discards subsequent instructions being executed, and re-executes the instruction of which a subnormal number has been detected from the I/O data. If, at step S204, it is not determined that a subnormal number has been detected (NO at step S204), the process proceeds to step S207.

In the subnormal number processing, the instruction control unit 110 re-issues the instruction to the operation execution unit 120 in the subnormal number processing mode. At step S206, the operation execution unit 120 re-executes the instruction received from the instruction control unit 110, using the operation unit 122. At this point, the instruction control unit 110 sends a notification to the operation unit 122 in the operation execution unit 120 that a subnormal number is included in the I/O data, the operation unit 122 operates in the subnormal number processing mode, and the operation unit 122 performs a preprocessing of the input or a post-processing of an operation result using a circuit for processing a subnormal number. As a result, an operation result from the operation unit 122 in the operation execution unit 120 is stored into the reorder buffer 124, a processed instruction is stored into the entry buffer 111, and the process proceeds to step S207.

At step S207, the instruction control unit 110 commits the instruction. After step S207, the process reverts to step S201, and an execution of a subsequent instruction is performed. When committing the instruction at step S207, if the CPU 100 is in the subnormal number processing mode, after the CPU 100 transits to a normal processing mode, the process reverts to step S201. Further, if the CPU 100 is in the subnormal number processing mode, the CPU 100 may estimate latency required for re-execution of the instruction, and after a time corresponding to the latency has passed, the CPU 100 may determine that an operation of the instruction is completed and may commit the instruction.

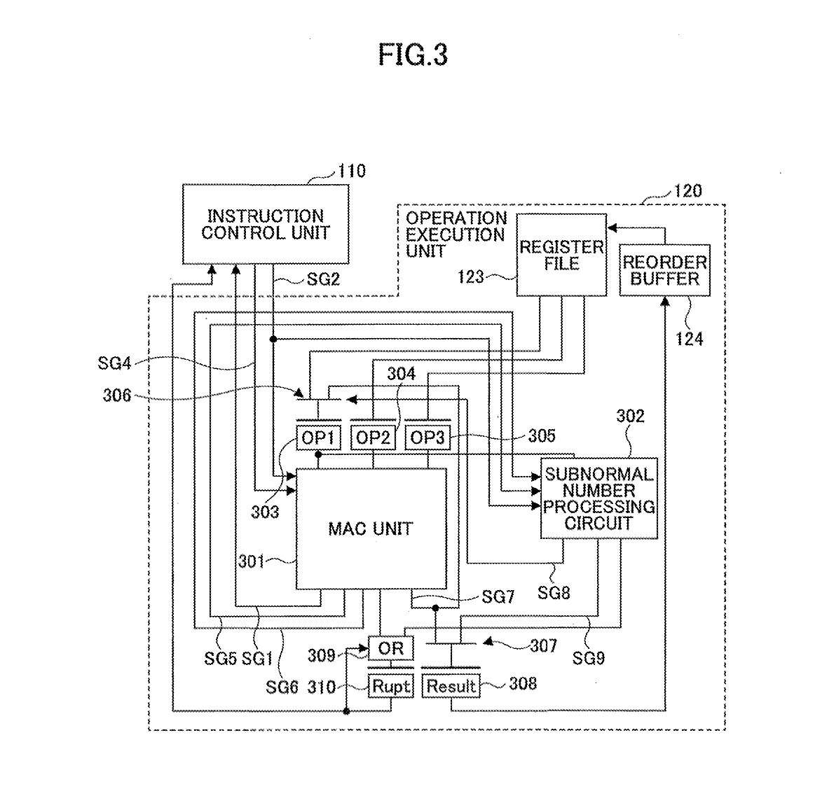

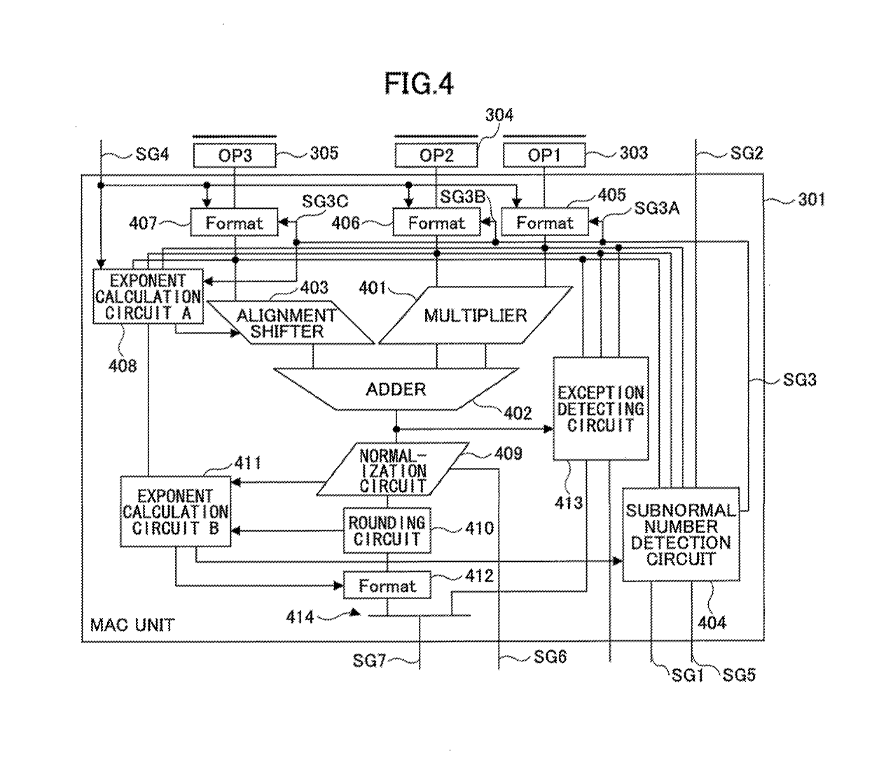

FIG. 3 is a diagram illustrating a configuration example of the operation execution unit 120 according to the first embodiment. With respect to an element in FIG. 3 having the same function as that illustrated in FIG. 1, the same reference symbol is attached, and the duplicate description of the element will be omitted. FIG. 3 illustrates an example in which the operation unit 122 in the operation execution unit 120 includes a floating-point multiplier-accumulator unit 301 (denoted as “MAC UNIT 301” in the drawings; also in the following description, the floating-point multiplier-accumulator unit 301 may be referred to as the “MAC unit 301”) and a subnormal number processing circuit 302. The floating-point multiplier-accumulator unit 301 performs a multiply-accumulate operation of operands (input data) OP1, OP2, and OP3 retained in registers 303, 304, and 305 respectively, and outputs an operation result SG7. An example of a configuration of the floating-point multiplier-accumulator unit 301 is illustrated in FIG. 4.

FIG. 4 is a diagram illustrating an example of the configuration of the floating-point multiplier-accumulator unit 301. The floating-point multiplier-accumulator unit 301 includes a multiplier 401, an adder 402, an alignment shifter 403, a subnormal number detection circuit 404, format circuits 405, 406, 407, and 412, exponent calculation circuits 408 and 411, a normalization circuit 409, a rounding circuit 410, an exception detecting circuit 413, and a selector 414.

The multiplier 401 multiplies significands of the operands OP1 and OP2 retained in the registers 303 and 304 that are entered via the format circuits 405 and 406, and outputs an operation result. The adder 402 adds the operation result output by the multiplier 401 and a significand of the operand OP3 retained in the register 305 that is entered via the format circuit 407, and outputs an operation result. Note that the significand of the operand OP3 is entered to the adder 402 after the significand of the operand OP3 is aligned by the alignment shifter 403 based on a calculation result of the exponent calculation circuit A 408. As described above, a result of a multiply-accumulate operation (of significands) is output by multiplying the operands OP1 and OP2 and by adding the operand OP3 to the product of the operands OP1 and OP2.

The subnormal number detection circuit 404 detects a subnormal number from I/O data of the MAC unit 301, and outputs detected results as signals SG1, SG3, and SG5. The subnormal number detection circuit 404 determines whether the operands OP1, OP2, and OP3 retained in the registers 303 to 305 that are entered via the format circuits 405 to 407 are subnormal numbers or not, and whether the result of the multiply-accumulate operation is a subnormal number or not. As a result of the determination, if at least one of the input operands OP1, OP2, and OP3 and the result of the multiply-accumulate operation is a subnormal number, the subnormal number detection circuit 404 outputs the signal SG1. Further, if the input operand OP1, OP2, or OP3 is a subnormal number, the subnormal number detection circuit 404 outputs the corresponding signal SG3 (signal SG3A, SG3B, and SG3C respectively correspond to the input operand OP1, OP2, or OP3). Further, if the result of the multiply-accumulate operation is a subnormal number, the subnormal number detection circuit 404 outputs the signal SG5.

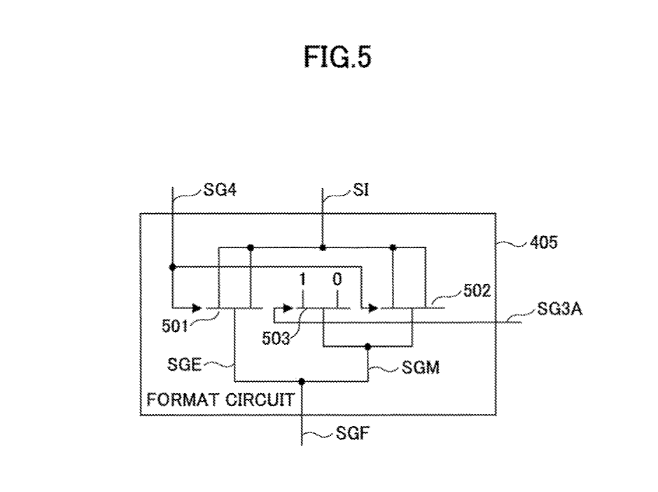

The format circuits 405, 406, and 407 form input data into exponents and significands (including hidden bits) in accordance with a size (double precision or single precision in the present embodiment) of a floating-point number. An example of a configuration of the format circuit 405, 406, or 407 is illustrated in FIG. 5. Though FIG. 5 illustrates the configuration of the format circuit 405 as an example, format circuits 406 and 407 also have similar configurations.

The format circuit 405 includes selectors 501, 502, and 503. Out of input data SI, bits corresponding to an exponent of a double precision floating-point number, and bits corresponding to an exponent of a single precision floating-point number are entered to the selector 501. Similarly, out of input data SI, bits corresponding to a significand of a double precision floating-point number, and bits corresponding to a significand of a single precision floating-point number are entered to the selector 502. The selectors 501 and 502 select either one of the two inputs in accordance with a size of a floating-point number specified with a signal SG4 from the instruction control unit 110, and output the selected one.

To the selector 503, values 1 and 0 (which are values of a hidden bit) are entered, and the selector 503 selects one of the values in accordance with the signal SG3A output by the subnormal number detection circuit 404, and outputs the selected one. When the signal SG3A indicates that the OP1 is not a subnormal number, the selector 503 outputs a value 1, and when the signal SG3A indicates that the OP1 is a subnormal number, the selector 503 outputs a value 0. The output of the selector 501 will be an exponent SGE, and a concatenated result of the output of the selector 503 and the output of the selector 502 will be a significand SGM. The format circuit 405 concatenates the exponent SGE and the significand SGM, and outputs the concatenated result as a floating-point number SGF.

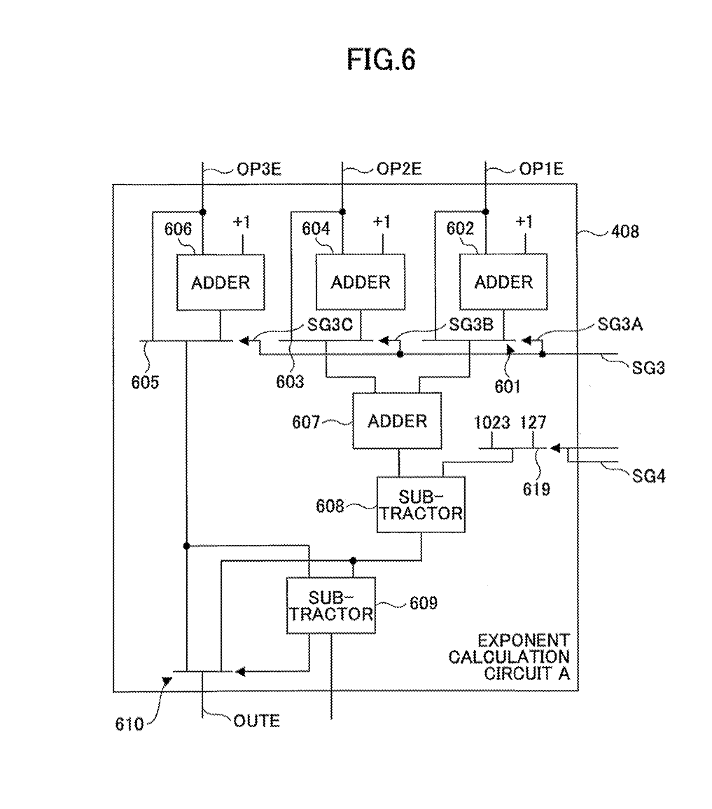

Referring back to FIG. 4, the exponent calculation circuit A 408 calculates an exponent of the operation result before normalization, based on exponents OP1E, OP2E, and OP3E of the input operands (OP1, OP2, and OP3). An example of a configuration of the exponent calculation circuit A 408 is illustrated in FIG. 6. The exponent calculation circuit A 408 includes selectors 601, 603, 605, and 619, adders 602, 604, 606, and 607, and subtractors 608 and 609.

The exponent OP1E of the operand OP1, and a sum of the exponent OP1E and 1 calculated by the adder 602, are entered to the selector 601. Similarly, the exponent OP2E of the operand OP2, and a sum of the exponent OP2E and 1 calculated by the adder 604, are entered to the selector 603, and the exponent OP3E of the operand OP3, and a sum of the exponent OP3E and 1 calculated by the adder 606, are entered to the selector 605. Note that the processes performed by the adders 602, 604 and 606 are adjustments to subnormal numbers. However, as all bits of an exponent of a subnormal number are zero, the adjustment may be made by setting a least significant bit to “1”.

Each of the selectors 601, 603, and 605 selects either one of the input values in accordance with the signal SG3 (SG3A, SG3B, and SG3C) output by the subnormal number detection circuit 404. When the signal SG3 indicates that the operand is not a subnormal number, the selectors 601, 603, and 605 select and output the exponents OP1E, OP2E, and OP3E respectively. When the signal SG3 indicates that the operand is a subnormal number, the selectors 601, 603, and 605 select and output the outputs of the adders 602, 604, and 606 respectively. The adder 607 adds an output of the selector 601 and an output of the selector 603. The subtractor 608 subtracts an output value of the selector 619 from an output of the adder 607. Note that the selector 619 outputs a value of 1023 or 127, in accordance with a size of a floating-point number specified with the signal SG4 from the instruction control unit 110. By the operations described above, an exponent of a product of the operands OP1 and OP2 is calculated.

The subtractor 609 performs subtraction of an output of the selector 605 and an output of the subtractor 608, and outputs an operation result. Based on the output of the subtractor 609, size relation of the product of the operands OP1 and OP2 and the operand OP3 can be identified. Further, the output of the selector 605 and the output of the subtractor 608 are entered to the selector 610, and the selector 610 selects either of the two inputs in accordance with the output of the subtractor 609, and outputs the selected input as the exponent OUTE of the operation result before normalization.

Referring back to FIG. 4, the normalization circuit 409 normalizes the output of the adder 402, which is (a significand of) the operation result of the multiply-accumulate operation of the operands OP1, OP2, and OP3. The rounding circuit 410 performs a rounding process of the value normalized by the normalization circuit 409. The exponent calculation circuit B 411 calculates an exponent of the normalized operation result, based on the exponent OUTE of the operation result before normalization calculated by the exponent calculation circuit A 408, and on processing results of the normalization circuit 409 and the rounding circuit 410.

The format circuit 412 forms and outputs an exponent and a significand of the operation result, by using the output of the exponent calculation circuit B 411 and the output of the rounding circuit 410. The exception detecting circuit 413 detects occurrence of an exception defined in the IEEE 754-2008. The selector 414 outputs the output of the format circuit 412 or the output of the exception detecting circuit 413, as an operation result SG7 of the floating-point multiplier-accumulator unit 301.

Referring back to FIG. 3, the subnormal number processing circuit 302 performs a process related to a subnormal number when in the subnormal number processing mode. To the subnormal number processing circuit 302, the operation result SG7 of the floating-point multiplier-accumulator unit 301 is entered as an operand OP1 via the selector 306 and the register 303. The subnormal number processing circuit 302 performs a shift processing and a rounding processing of the input operand OP1, in accordance with an exponent of the operand OP1, and outputs an operation result SG9.

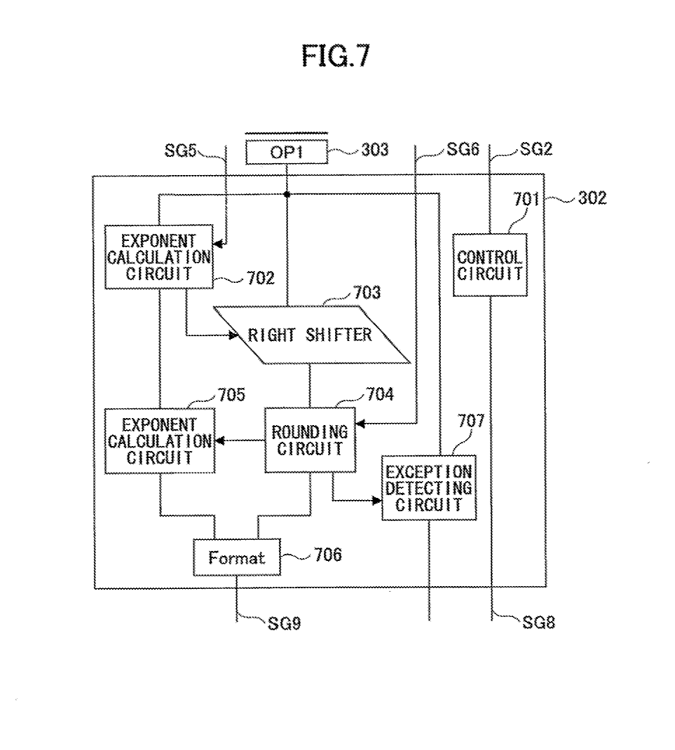

In a case in which an exponent of the operand OP1 is negative, the operand OP1 is a subnormal number. Therefore in this case, the subnormal number processing circuit 302 performs a right-shift operation of a significand until an exponent becomes positive, and performs rounding of the shifted result. Conversely, in a case in which an exponent of the operand OP1 is positive, the operand OP1 is not a subnormal number. Therefore in this case, the subnormal number processing circuit 302 performs the rounding process without performing a right-shift operation. An example of a configuration of the subnormal number processing circuit 302 is illustrated in FIG. 7.

FIG. 7 is a diagram illustrating an example of the configuration of the subnormal number processing circuit 302. The subnormal number processing circuit 302 includes a control circuit 701, an exponent calculation circuit 702, a right shifter circuit 703 (denoted as “RIGHT SHIFTER” in the drawing), a rounding circuit 704, an exponent calculation circuit 705, a format circuit 706, and an exception detecting circuit 707. The control circuit 701 outputs a selection control signal SG8 for the selector 306, based on the signal SG2 from the instruction control unit 110 indicating that the CPU 100 is in the subnormal number processing mode.

The exponent calculation circuit 702 calculates a shift amount to be performed in the right shifter circuit 703, based on the exponent of the input operand OP1. The right shifter circuit 703 performs a right shift of the significand of the operand OP1 until the exponent of the operand OP1 becomes positive, based on the calculated result of the exponent calculation circuit 702. The rounding circuit 704 performs a rounding process of an output value of the right shifter circuit 703.

The exponent calculation circuit 705 calculates an exponent of the operation result based on the exponent calculated by the exponent calculation circuit 702 and the processing result of the rounding circuit 704. The format circuit 706 forms an exponent and a significand of the operation result, by using the output of the exponent calculation circuit 705 and the output of the rounding circuit 704, and outputs the operation result SG9. The exception detecting circuit 707 detects two types of exception, underflow and inexact.

Referring back to FIG. 3, the selector 307 outputs either one of the operation result SG7 from the floating-point multiplier-accumulator unit 301 and the operation result SG9 from the subnormal number processing circuit 302. When the CPU 100 is not in the subnormal number processing mode, the selector 307 selects and outputs the operation result SG7 from the floating-point multiplier-accumulator unit 301. And, when the CPU 100 is in the subnormal number processing mode, the selector 307 selects and outputs the operation result SG9 from the subnormal number processing circuit 302. The operation result SG7 or SG9 is stored into the reorder buffer 124 via the register 308. Exception notifications from the floating-point multiplier-accumulator unit 301 and the subnormal number processing circuit 302 are entered to an OR operation gate 309 (hereinafter referred to as an “OR gate 309”). An exception determination unit 310 determines whether an exception has occurred or not, based on an output of the OR gate 309, and if an exception has occurred, the exception determination unit 310 sends a notification to the instruction control unit 110.

Next, an operation of the first embodiment will be described.

In response to an instruction from the instruction control unit 110, when the operation execution unit 120 is to execute the instruction using the MAC unit 301, the subnormal number detection circuit 404 in the MAC unit 301 detects a subnormal number from I/O data. If a subnormal number is not detected from the I/O data, the operation execution unit 120 performs a normal arithmetic operation using the MAC unit 301, and outputs the operation result SG7.

If a subnormal number has been detected from the I/O data, the MAC unit 301 in the operation execution unit 120 outputs the signal SG1 to the instruction control unit 110. Then, at a time when the instruction of which a subnormal number has been detected from the I/O data is committed (completed), the CPU 100 transits to a subnormal number processing mode based on the signal SG1. While in the subnormal number processing mode, the instruction control unit 110 outputs the signal SG2 indicating that the CPU 100 is in the subnormal number processing mode to each operation unit. Also, in the subnormal number processing mode, the instruction of which a subnormal number has been detected from the I/O data is re-executed in the operation execution unit 120 in the following manner.

When transiting to the subnormal number processing mode, contents retained in the entry buffer of the instruction control unit 110 and the reorder buffer 124 in the operation execution unit 120 are discarded. Subsequent instructions being executed are also discarded. Further, the CPU 100 operates in a single instruction mode for suppressing execution of subsequent instructions, and the instruction of which a subnormal number has been detected from the I/O data is executed.

The MAC unit 301 in the operation execution unit 120 starts an arithmetic operation of the instruction of which a subnormal number has been detected from the I/O data, and determines whether the input operands OP1, OP2, and OP3 are subnormal numbers or not using the subnormal number detection circuit 404. If a subnormal number is included in the input operand OP1, OP2, or OP3, the signal SG3 is fed from the subnormal number detection circuit 404 to the format circuits 405 to 407 and to the exponent calculation circuit A 408, and the MAC unit 301 starts the arithmetic operation from the beginning. Here, hidden bits of significands are turned off in the format circuits 405 to 407, and an adjustment of an exponent is performed in the exponent calculation circuit A 408.

The MAC unit 301 performs an arithmetic operation that is the same operation as a normal operation except the rounding process, and outputs a result. Here, the subnormal number detection circuit 404 determines whether the result of the arithmetic operation is a subnormal number or not, and if the result is a subnormal number, the signal SG5 is output to the subnormal number processing circuit 302. In the present embodiment, a rounding toward zero defined in the IEEE 754-2008 is performed, and a signal SG6, which includes values of a guard bit, a round bit, and a sticky bit (these are necessary information for a rounding), is output from the normalization circuit 409 to the subnormal number processing circuit 302.

As described above, the signals SG5 and SG6 from the MAC unit 301 are entered into the subnormal number processing circuit 302. Additionally, the operation result SG7 of the MAC unit 301 is entered, and a process of the operation result SG7 is performed. Because a data bypass for inputting the operation result SG7 of the MAC unit 301 into the subnormal number processing circuit 302 is a path that is used in a normal operation, no additional hardware is required to implement a technique of the present embodiment. Also, in a normal operation, the instruction control unit 110 determines from which data path the register 303 should store data, but in the subnormal number processing mode, the subnormal number processing circuit 302 specifies data to be stored into the register 303 by using the selection control signal SG8.

In a case in which an exponent of the operation result SG7 is negative, the operation result of the instruction is a subnormal number. In this case, the subnormal number processing circuit 302 performs a right-shift operation of a significand until an exponent of the operation result SG7 becomes positive, performs rounding of the shifted result, and outputs the operation result SG9. Conversely, in a case in which an exponent of the operation result SG7 is positive, the operation result of the instruction is not a subnormal number. Therefore in this case, the subnormal number processing circuit 302 performs a rounding process without performing a right-shift operation, and outputs the operation result SG9. In this case, a shift amount is determined to be 0 based on the signal SG5 from the MAC unit 301, the subnormal number processing circuit 302 performs the same rounding process as that performed in the MAC unit 301 in a normal operation, and outputs the operation result.

After the subnormal number processing circuit 302 terminates the arithmetic operation by outputting the operation result SG9 and the instruction of which a subnormal number has been detected from the I/O data is committed, the CPU 100 transits from the subnormal number processing mode to the normal processing mode, and starts processing the subsequent instructions.

According to the first embodiment, if a subnormal number has been detected during an arithmetic operation related to an instruction, the instruction is re-executed when a commit processing (completion processing) of the instruction is performed. Therefore, a subnormal number can be processed by hardware in a high speed without complicating control so as not to deteriorate latency of an operation of only normal numbers.

### Second Embodiment

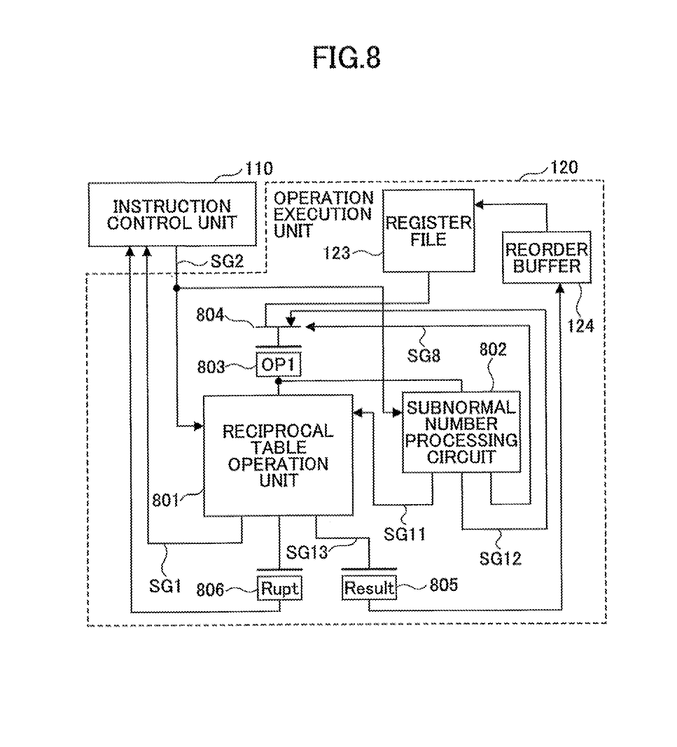

Next, a second embodiment will be described. Because an overall configuration of a CPU as a processing device and an instruction processing according to the second embodiment are similar as described in the first embodiment, the descriptions thereof will be omitted. FIG. 8 is a diagram illustrating a configuration example of the operation execution unit 120 according to the second embodiment. With respect to an element in FIG. 8 having the same function as that illustrated in FIG. 1, the same reference symbol is attached, and the duplicate description of the element will be omitted.

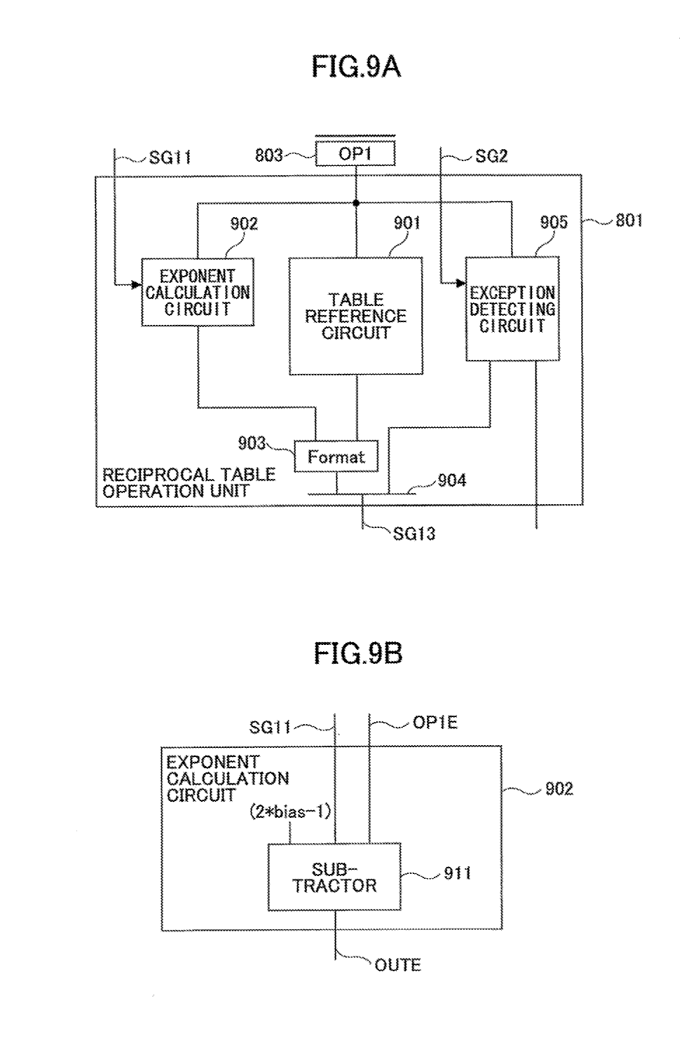

FIG. 8 illustrates an example in which the operation execution unit 120 includes a floating-point reciprocal table operation unit 801 (denoted as “reciprocal table operation unit 801” in the drawings) and a subnormal number processing circuit 802. The floating-point reciprocal table operation unit 801 performs an approximating arithmetic operation for calculating a reciprocal of a floating-point number with respect to an operand OP1 retained in a register 803, and output an operation result SG13 (a reciprocal of the operand OP1). When not in the subnormal number processing mode, data in the register file 123 is stored into the register 803 via a selector 804. When in the subnormal number processing mode, an operation result SG12 of the subnormal number processing circuit 802 is stored into the register 803 via the selector 804. A configuration example of the floating-point reciprocal table operation unit 801 is illustrated in FIG. 9A.

FIG. 9A is a diagram illustrating a configuration example of the floating-point reciprocal table operation unit 801. The floating-point reciprocal table operation unit 801 includes a table reference circuit 901, an exponent calculation circuit 902, a format circuit 903, a selector 904, and an exception detecting circuit 905. The table reference circuit 901 refers to a table using, as a key, a value of a significand of the input operand OP1 having been retained in the register 803, to output a significand of a reciprocal of the operand OP1.

The exponent calculation circuit 902 is configured, for example, as illustrated in FIG. 9B. The exponent calculation circuit 902 calculates and outputs an exponent OUTE of a reciprocal of the operand OP1, based on an exponent OP1E of the input operand OP1 and a signal SG11 from the subnormal number processing circuit 802. The signal SG11 indicates whether the exponent of the input operand OP1 is a negative value or not. The exponent calculation circuit 902 performs a subtraction operation of (2×bias−1) and the exponent OP1E using the signal SG11 as a sign bit of the exponent, and outputs an operation result as the exponent OUTE of the reciprocal.

The format circuit 903 forms and outputs an exponent and a significand of the operation result, by using the output of the exponent calculation circuit 902 and the output of the table reference circuit 901. The selector 904 outputs the output of the format circuit 903 or the output of the exception detecting circuit 905, as the operation result SG13 of the floating-point reciprocal table operation unit 801. The exception detecting circuit 905 detects occurrence of an exception defined in the IEEE 754-2008.

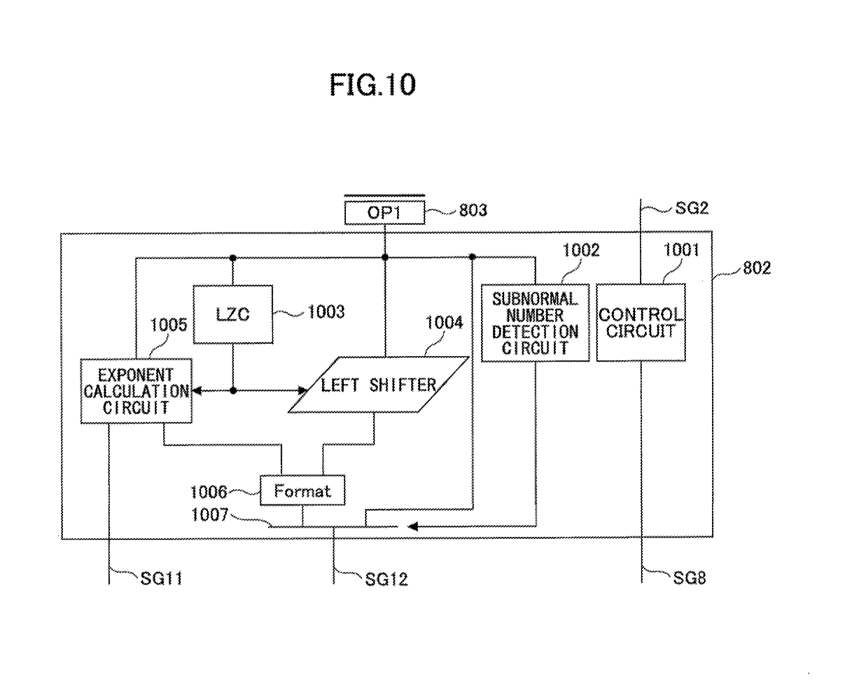

In a case in which the input operand OP1 retained in the register 803 is a subnormal number, the subnormal number processing circuit 802 normalizes the subnormal number (a significand is left-shifted until an integer bit becomes 1). The subnormal number processing circuit 802, in a case in which the operand OP1 is a subnormal number, outputs the signal SG11 indicating that an exponent of a normalized operand OP1 is a negative value, and outputs the operation result SG12 which is a normalized operand OP1. An example of a configuration of the subnormal number processing circuit 802 is illustrated in FIG. 10.

FIG. 10 is a diagram illustrating an example of the configuration of the subnormal number processing circuit 802. The subnormal number processing circuit 802 includes a control circuit 1001, a subnormal number detection circuit 1002, a leading zero counter (LZC) circuit 1003, a left shifter circuit 1004 (denoted as “LEFT SHIFTER” in the drawing), an exponent calculation circuit 1005, a format circuit 1006, and a selector 1007. The control circuit 1001 outputs a selection control signal SG8 for the selector 804, based on the signal SG2 from the instruction control unit 110 indicating that the CPU 100 is in the subnormal number processing mode.

The subnormal number detection circuit 1002 determines whether the input operand OP1 retained in the register 803 is a subnormal number or not, and outputs a determined result as a selection control signal of the selector 1007. The LZC circuit 1003 counts the number of 0's successively located from a head of the significand of the input operand OP1. The left shifter circuit 1004 performs a left-shift of the significand of the operand OP1 in accordance with the number of 0's counted by the LZC circuit 1003. The exponent calculation circuit 1005 subtracts the number of 0's counted by the LZC circuit 1003 from the exponent of the operand OP1. By performing the above operations, the operand OP1, which is a subnormal number, is normalized. Because an exponent of a normalized subnormal number is less than zero, the exponent calculation circuit 1005 outputs the signal SG11 indicating that the exponent is of negative value.

The format circuit 1006 forms and outputs an exponent and a significand of the normalized subnormal number, by using the output of the exponent calculation circuit 1005 and the output of the left shifter circuit 1004. The selector 1007 outputs, as the operation result SG12, the output of the format circuit 1006, if the input operand OP1 is a subnormal number. If the input operand OP1 is a not a subnormal number, the selector 1007 outputs the operand OP1 as the operation result SG12.

A register 805 stores the operation result SG13 output from the floating-point reciprocal table operation unit 801. The operation result SG13 stored in the register 805 is stored into the reorder buffer 124. An exception determination unit 806 determines whether an exception has occurred or not, based on an output of the floating-point reciprocal table operation unit 801, and if an exception has occurred, the exception determination unit 806 sends a notification to the instruction control unit 110.

In the second embodiment, in response to an instruction from the instruction control unit 110, when the operation execution unit 120 is to execute the instruction using the floating-point reciprocal table operation unit 801, detecting a subnormal number is performed from input data. If a subnormal number is not detected from the input data, the operation execution unit 120 performs a normal arithmetic operation using the floating-point reciprocal table operation unit 801, and outputs the operation result SG13.

If a subnormal number has been detected from the input data, the signal SG1 is output to the instruction control unit 110. Then, at a time when the instruction of which a subnormal number has been detected from the input data is committed (completed), the CPU 100 transits to a subnormal number processing mode based on the signal SG1. While in the subnormal number processing mode, the instruction control unit 110 outputs the signal SG2 indicating that the CPU 100 is in the subnormal number processing mode to each operation unit. Also, in the subnormal number processing mode, the instruction of which a subnormal number has been detected from the input data is re-executed in the operation execution unit 120 in the following manner.

When transiting to the subnormal number processing mode, contents retained in the entry buffer of the instruction control unit 110 and the reorder buffer 124 in the operation execution unit 120 are discarded. Subsequent instructions being executed are also discarded. Further, the CPU 100 operates in a single instruction mode for suppressing execution of subsequent instructions, and the instruction of which a subnormal number has been detected from the input data is executed.

The subnormal number processing circuit 802 in the operation execution unit 120 determines whether the input operand OP1 is a subnormal number or not. If the input operand OP1 is a subnormal number, the LZC circuit 1003 detects the number of 0's successively located from a head of a significand of the operand OP1. Subsequently, the significand of the operand OP1 is left-shifted in accordance with the number detected by the LZC circuit 1003, and an exponent is subtracted by the exponent calculation circuit 1005, to normalize the operand OP1 which was a subnormal number. Because an exponent of a normalized subnormal number is less than zero, the subnormal number processing circuit 802 generates and outputs the signal SG11 for notifying the floating-point reciprocal table operation unit 801 that the exponent is of negative value.

By performing the above process, the signal SG11 from the subnormal number processing circuit 802 is entered to the floating-point reciprocal table operation unit 801, and the operation result SG12 of the subnormal number processing circuit 802 is also entered. Because a data bypass for inputting the operation result SG12 of the subnormal number processing circuit 802 into the floating-point reciprocal table operation unit 801 is a path that is used in a normal operation, no additional hardware is required to implement a technique of the present embodiment. Also, in a normal operation, the instruction control unit 110 determines from which data path the register 803 should store data, but in the subnormal number processing mode, the subnormal number processing circuit 802 specifies data to be stored into the register 803 by using the selection control signal SG8.

Even when the input operand OP1 is a subnormal number, calculation of a significand in the floating-point reciprocal table operation unit 801 is performed in a same manner when the input operand OP1 is a normal number. Calculation of an exponent is performed by using the signal SG11 as a sign bit of the exponent. After the floating-point reciprocal table operation unit 801 terminates the arithmetic operation by outputting the operation result SG13 and the instruction of which a subnormal number has been detected from the input data is committed, the CPU 100 transits from the subnormal number processing mode to the normal processing mode, and starts processing the subsequent instructions.

According to the second embodiment, if input data is a subnormal number, the input data is normalized and an arithmetic operation is performed using the normalized data. Therefore, a subnormal number can be processed by hardware in a high speed without complicating control so as not to deteriorate latency of an operation of only normal numbers.

### Third Embodiment

Next, a third embodiment will be described. Because an overall configuration of a CPU as a processing device and an instruction processing according to the third embodiment are similar as described in the first embodiment, the descriptions thereof will be omitted. In the operation execution unit 120 according to the third embodiment, multiple floating-point multiplier-accumulator units (MAC units) 301 are provided, and a SIMD operation is performed.

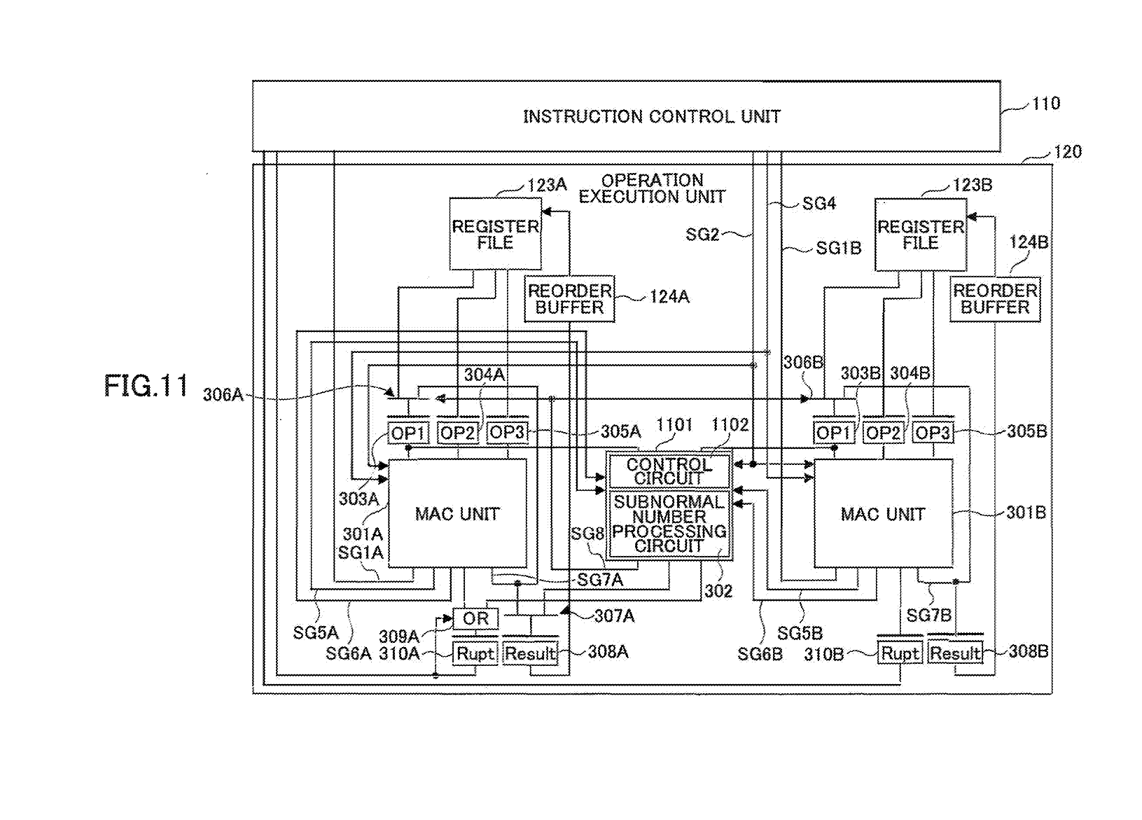

FIG. 11 is a diagram illustrating a configuration example of the operation execution unit 120 according to the third embodiment. Though an example of a two-parallel SIMD operating unit is illustrated in FIG. 11, the operation execution unit 120 is not limited to the two-parallel SIMD operating unit. By using n elements of floating-point multiplier-accumulator units 301, n-parallel SIMD operating unit can be implemented.

With respect to an element in FIG. 11 having the same function as that illustrated in FIG. 1 or FIG. 3, the same reference symbol is attached, and the duplicate description of the element will be omitted. Also in FIG. 11, with respect to elements related to the floating-point multiplier-accumulator units 301, reference symbols followed by suffixes are attached. Specifically, to each element related to a first floating-point multiplier-accumulator unit (MAC unit) 301A, a reference symbol followed by a suffix A is used. Similarly, to each element related to a second floating-point multiplier-accumulator unit (MAC unit) 301B, a reference symbol followed by a suffix B is used.

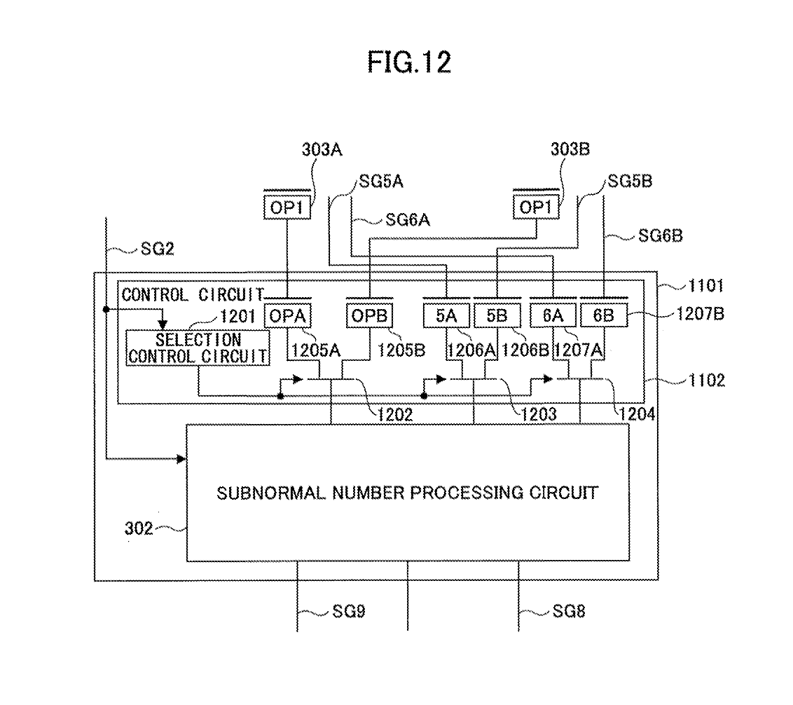

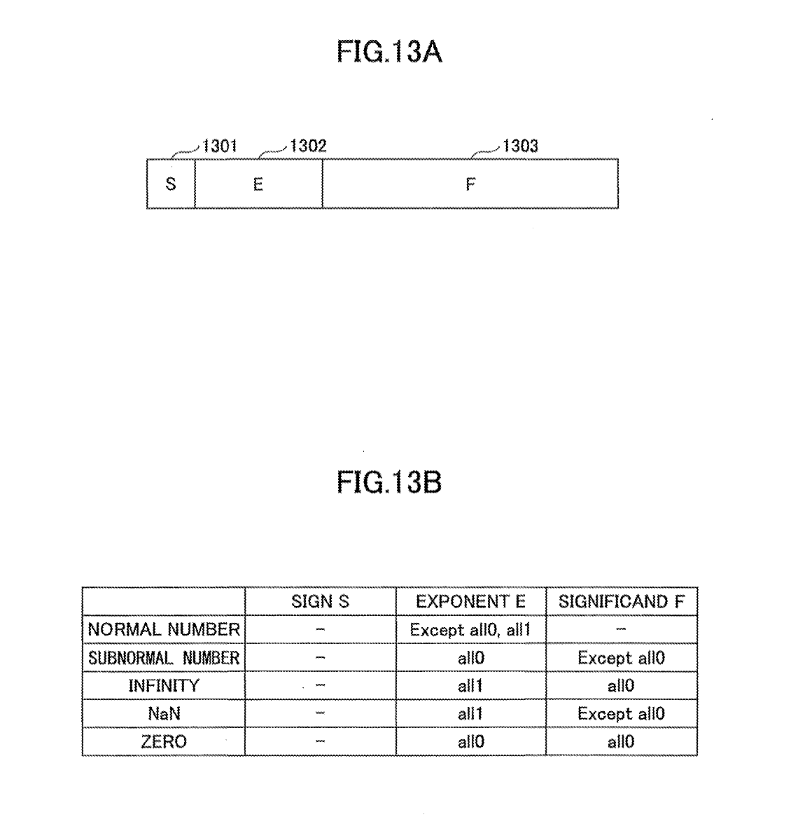

In the operation execution unit 120 according to the third embodiment, a processing circuit 1101 performs a process of a subnormal number. The processing circuit 1101 includes the subnormal number processing circuit 302 and a control circuit 1102. As illustrated in FIG. 12, the control circuit 1102 includes a selection control circuit 1201, selectors 1202, 1203, and 1204, and registers 1205A, 1205B, 1206A, 1206B, 1207A, and 1207B.

The selection control circuit 1201 controls the selectors 1202, 1203, and 1204. An operand OP1 (OPA) retained in a register 303A is entered to the selector 1202 via the register 1205A, and an operand OP1 (OPB) retained in a register 303B is entered to the selector 1202 via the register 1205B. A signal SG5A from the first MAC unit 301A is entered to the selector 1203 via the register 1206A, and a signal SG5B from the second MAC unit 301B is entered to the selector 1203 via the register 1206B. Further, a signal SG6A from the first MAC unit 301A is entered to the selector 1204 via the register 1207A, and a signal SG6B from the second MAC unit 301B is entered to the selector 12045 via the register 1207B.

The selectors 1202, 1203, and 1204 select an operand and signals related to a MAC unit 301 specified with a selection control signal from the selection control circuit 1201, and output the selected operand and signals to the subnormal number processing circuit 302. That is, if, for example, a selection control signal from the selection control circuit 1201 indicates that an operand and signals related to the first MAC unit 301A should be output, the selectors 1202, 1203, and 1204 respectively select the operand OPA and the signals SGSA and SG6A, and output the selected operand and signals to the subnormal number processing circuit 302. Similarly, if, for example, a selection control signal from the selection control circuit 1201 indicates that an operand and signals related to the second MAC unit 301B should be output, the selectors 1202, 1203, and 1204 respectively select the operand OPB and the signals SG5B and SG6B, and output the selected operand and signals to the subnormal number processing circuit 302.

In response to an instruction from the instruction control unit 110, when the operation execution unit 120 is to execute a SIMD instruction using the MAC units 301A and 301B, each of the subnormal number detection circuits 404 in the MAC units 301A and 301B detects a subnormal number from I/O data. If a subnormal number is not detected from the I/O data in either of the MAC units 301A and 301B, the operation execution unit 120 performs a normal arithmetic operation using the MAC units 301A and 301B, and outputs the operation results SG7A and SG7B.

If a subnormal number has been detected from the I/O data in the MAC unit 301 (301A or 301B), the MAC unit 301 (301A or 301B) outputs the signal SG1 (SG1A or SG1B) to the instruction control unit 110. Then, at a time when the SIMD instruction of which a subnormal number has been detected from the I/O data is committed (completed) in the instruction control unit 110, if a subnormal number has been detected in at least one of the MAC units 301 (301A and 301B), the CPU 100 transits to a subnormal number processing mode based on the signal SG1 (SG1A or SG1B). While in the subnormal number processing mode, the instruction control unit 110 outputs the signal SG2 indicating that the CPU 100 is in the subnormal number processing mode to each operation unit. Also, in the subnormal number processing mode, the SIMD instruction of which a subnormal number has been detected from the I/O data is re-executed in the operation execution unit 120 in the following manner.

When transiting to the subnormal number processing mode, contents retained in the entry buffer of the instruction control unit 110 and the reorder buffer 124 in the operation execution unit 120 are discarded. Subsequent instructions being executed are also discarded. Further, the CPU 100 operates in a single instruction mode for suppressing execution of subsequent instructions, and the instruction of which a subnormal number has been detected from the I/O data is executed.

The MAC units 301A and 301B in the operation execution unit 120 start an arithmetic operation of the SIMD instruction of which a subnormal number has been detected from the I/O data. By control of the selection control circuit 1201, a process of a subnormal number for the MAC unit 301A and a process of a subnormal number for the MAC unit 301B are started sequentially. For example, by implementing the selection control circuit 1201 using a counter, the selection control circuit 1201 can select a value corresponding to the MAC units 301 (301A and 301B) sequentially. In the present embodiment, though only one subnormal number processing circuit 302 is present, multiple subnormal number processing circuits 302 may be installed in order to perform parallel processing. A method of an arithmetic operation performed in the subnormal number processing circuit 302 of the third embodiment is the same as that in the first embodiment. In a case in which an arithmetic operation of a SIMD instruction is performed in the subnormal number processing mode, an overflow exception may occur, in addition to an underflow exception and an inexact exception. Accordingly, any of the three exceptions including an overflow exception that has occurred by a rounding may be merged with an exception that has been previously detected in the MAC unit by calculating an inclusive OR.

After the subnormal number processing circuit 302 terminates arithmetic operations and the instruction of which a subnormal number has been detected from the I/O data is committed, the CPU 100 transits from the subnormal number processing mode to the normal processing mode, and starts processing the subsequent instructions.

According to the third embodiment, similar to the first embodiment, if a subnormal number has been detected during an arithmetic operation related to an instruction, the instruction is re-executed when a commit processing (completion processing) of the instruction is performed. Therefore, a subnormal number can be processed by hardware in a high speed without complicating control so as not to deteriorate latency of an operation of only normal numbers.

In the above description, formats of a floating-point number to be calculated in the processing device of the above embodiment were a double precision format or a single precision format, but the formats are not limited to the above two. In addition, it is possible to process two single precision floating-point numbers in parallel, by adding hardware resources and placing two single precision floating-point numbers in a 64-bit data path. Further, the above embodiments describe examples of a subnormal number processing with respect to one type of operation unit, but by applying techniques disclosed in the above embodiments together, the subnormal number processing mode can be added to multiple types of operation units.

All examples and conditional language provided herein are intended for pedagogical purposes of aiding the reader in understanding the invention and the concepts contributed by the inventors to further the art, and are not to be construed as limitation to such specifically recited examples and conditions, nor does the organization of such examples in the specification relate to a showing of superiority and inferiority of the invention. Although one or more embodiments of the present invention have been described in detail, it should be understood that various changes, substitutions, and alterations could be made hereto without departing from the spirit and scope of the invention.

What is claimed is:

1. A processing device comprising:
an instruction control unit configured to issue an instruction;
an operation unit configured to perform a floating-point operation in accordance with an instruction issued from the instruction control unit;
a detection unit configured to detect a subnormal number from data related to the floating-point operation performed in the operation unit; and
a processing unit configured to process the data in a case in which a subnormal number is included in the data,
the instruction control unit being further configured, when committing a given instruction in which a given floating-point operation was performed by the operation unit in accordance with the given instruction, in a case in which a subnormal number was detected during the given floating-point operation,
to cause the processing device to transit to a subnormal processing mode for processing a subnormal number,
to instruct the operation unit to re-execute the given instruction, and
to instruct the processing unit to process the detected subnormal number.

2. The processing device according to claim 1, wherein instructions being executed and subsequent to the given instruction are discarded when the processing device in the subnormal processing mode is operated in a single instruction mode for suppressing execution of subsequent instructions.

3. The processing device according to claim 1, wherein the processing unit is configured to perform a preprocessing of the subnormal number so as to be treated as a normal number, or to perform a post-processing of the subnormal number.

4. The processing device according to claim 1, wherein information of instructions subsequent to the given instruction is discarded when the processing device is in transiting to the subnormal processing mode.

5. A control method of a processing device including an instruction control unit, an operation unit configured to perform a floating-point operation, a detection unit configured to detect a subnormal number from data related to the floating-point operation performed in the operation unit, and a processing unit configured to process a subnormal number, the method comprising:
issuing an instruction from the instruction control unit to the operation unit;
performing, in the operation unit, the floating-point operation in accordance with the instruction received from the instruction control unit;
detecting, by the detection unit, a subnormal number from data related to the floating-point operation performed in accordance with the received instruction; and
in response to a commitment of the received instruction, in a case in which a subnormal number was detected during a given floating-point operation performed in accordance with the received instruction,
causing the processing device to transit to a subnormal processing mode for processing a subnormal number,
re-executing the received instruction by the operation unit, and
processing the detected subnormal number by the processing unit.
